(19) United States
(12) Patent Application Publication
(10) Pub. No.: US 2004/0024599 A1
(43) Pub. Date: Feb. 5, 2004

(54) Audio search conducted through statistical pattern matching

(75) Inventor: Michael E. Deisher, Hillsboro, OR (US)

Correspondence Address: Pillsbury Winthrop LLP, Intellectual Property Group, Suite 2800, 725 S. Figueroa St., Los Angeles, CA, 90017, US

(73) Assignee: Intel Corporation, Santa Clara, CA (US)

(21) Appl. No.: 10/210,754

(22) Filed: Jul. 31, 2002

(51) Int. Cl. G10L 15/14

(52) U.S. Cl. 704/256

(57) ABSTRACT

A technique for audio searches by statistical pattern matching is disclosed. The audio to be located is processed for feature extraction and decoded using a maximum likelihood (“ML”) search. A left-right Hidden Markov Model (“HMM”) is constructed from the ML state sequence. Transition probabilities are defined as normalized state occupancies from the most likely state sequence of the decoding operation. Utterance duration is measured from the search sample. Other model parameters are gleaned from an acoustic model. A ML search of an audio corpus is conducted with respect to the HMM and a garbage model. New start states are added at each frame. Low scoring and long state sequences (with respect to the search sample duration) are discarded at each frame. Locations where scores of the new model are higher than those of the garbage model are marked as potential matches. The highest scoring matches are presented as results.

### BACKGROUND

1. Technical Field

Embodiments described herein are directed to an audio search system based on statistical pattern matching. Specifically, the retrieval of audio notes or the search of large acoustic corpora is conducted using voice.

2. Related Art

Presently, most audio searching technology relies on complete decoding of speech material and a subsequent search of the corresponding text. The finest speech recognizers to date are complex, and their accuracy depends on many factors such as microphones, background noise, and vocabulary.

Research at the University of Cambridge has been performed on techniques for automatic keyword spotting using Hidden Markov Models (“HMMs”). The techniques, however, do not take advantage of the speaker's timing and duration information to focus the search. The proposed system improves upon previously conducted research by incorporating utterance and phoneme duration into the search.

Fast-Talk Communications has created a phonetic-based audio searching technology, in which content to be searched is first indexed by a phonetic preprocessing engine (“PPE”) during recording, broadcast, or from archives. The PPE lays down a high-speed phonetic search track parallel to the spoken audio track (time aligned in a video application). It also creates a discrete index file that becomes searchable immediately. Once a piece of content has been preprocessed by the PPE, it is ready for searching, and does not require further manipulation. Fast-Talk's technology uses a dictionary and spelling-to-sound rules to convert text to a phoneme string prior to search. That is, Fast-Talk's search engine requires a text example.

The proposed system is thus advantageous because it does not require a complete model of human speech. Neither a dictionary nor a language model is included in the system. Instead, the system allows a direct search of acoustic material using an acoustic example. Moreover, the audio search system does not attempt to solve the more complex problem of completely recognizing speech. Instead, the system functions simply to match an acoustic pattern.

### BRIEF DESCRIPTION OF THE DRAWINGS

A detailed description of embodiments of the invention will be made with reference to the accompanying drawings, wherein like numerals designate corresponding parts in the several figures.

FIG. 1 is a diagram of the components and operations involved in conducting audio searches through statistical pattern matching, according to an embodiment of the present invention.

FIG. 2 is a flowchart depicting the operations involved in conducting audio searches through statistical pattern matching, according to an embodiment of the present invention.

### DETAILED DESCRIPTION

Difficulties arise in searching a large corpus of previously recorded audio given a relatively short example of the sound to be found. The following paragraphs describe a system that conducts audio searches through statistical pattern matching to facilitate the process. The system leverages existing speech recognition techniques. Its application, however, is not necessarily limited to speech.

Consider, for example, an acoustic model consisting of hidden Markov models (“HMMs”) representing a set of sub-word units, e.g., phonemes, as well as non-speech sounds, such as but not limited to pauses, sighs, and environmental noises. A phoneme is the smallest meaningful contrastive unit in the sound system of a language. WEBSTER'S THIRD NEW INTERNATIONAL DICTIONARY 1700 (1986). An HMM is a probabilistic function of a Markov chain in which each state generates a random vector. Only these random vectors are observed, and the goal in statistical pattern recognition using HMMs is to infer the hidden state sequence. HMMs are useful for time-series modeling, since the discrete state-space can be used to approximate many man-made and naturally occurring signals reasonably well.

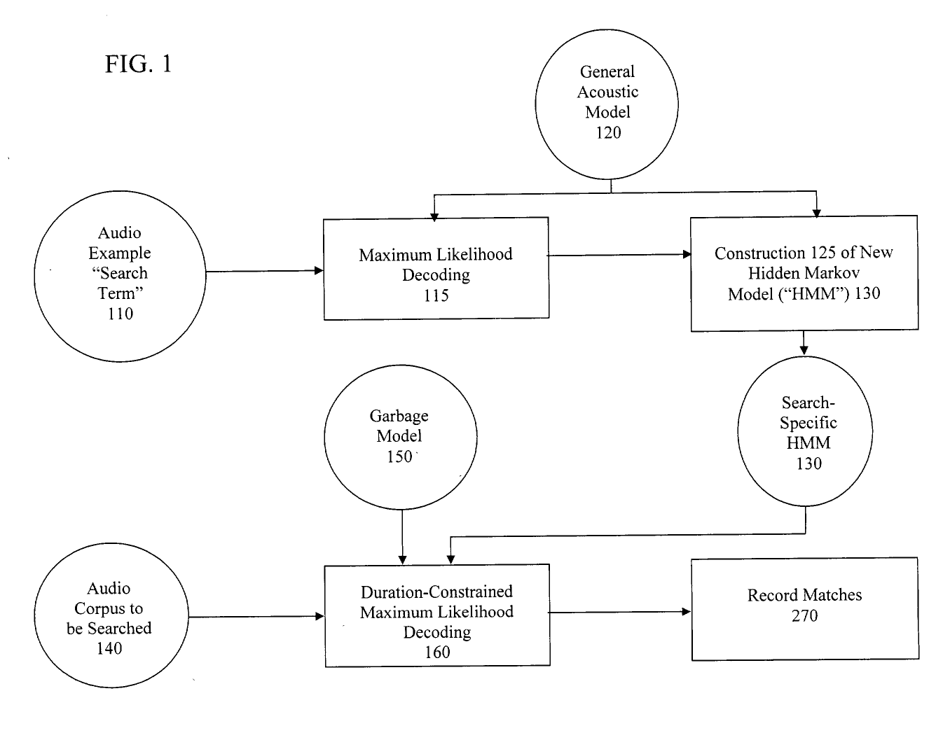

FIG. 1 shows an example of the main components and operations involved in conducting an audio search through statistical pattern matching using the method of the present invention. An audio search term 110 is processed once to perform feature extraction. Feature extraction is an important common denominator in recognition systems is the signal processing front-end, which converts a speech waveform into some type of parametric representation. The parametric representation is then used for further analysis and processing. Power spectral analysis, linear predictive analysis, perceptual linear prediction, Mel scale cepstral analysis, relative spectra filtering of log domain coefficients, first order derivative analysis, and energy normalization are various types of processing that are used in various combinations in various feature extractors.

The audio search term 110 is decoded using a maximum likelihood (“ML”) search 115 such as a Viterbi recursive computational procedure. For a particular HMM, the Viterbi calculation is used to find the most probable sequence of underlying hidden states of the HMM, given a sequence of observed feature vectors. The ML search 115 is conducted with respect to a general acoustic model 120. The general acoustic model 120 may be a speaker-independent HMM requiring no enrollment or a speaker-dependent HMM obtained via an enrollment session with an end user.

A search-specific left-right HMM 130 is constructed 125 from an ML state sequence, resulting from the ML search 115. The most likely sequence of states revealed during the ML search 115 may be assigned to the new search-specific model 130. The HMM parameters for the new search-specific model 130 may be copied directly from the general acoustic model 120. The state transition probabilities for the new left-right HMM 130 may be obtained by normalizing the state occupancy count resulting from the first ML search 115. In other words, the probability of transition from state i to state j in the new model is

$${a}_{ij} = \{ \begin{matrix}\frac{{N}_{i} - 1}{{N}_{i}} , j = i + 1 \\ \frac{1}{{N}_{i}} , j = i \\ 0 , otherwise \end{matrix}$$

where Nᵢ is the number of self transitions of the i^{th} state observed in the ML state sequence resulting from the first ML search 115.

Feature extraction is performed on the audio corpus 140. The audio corpus 140 may be a collection of audio notes that a user may have on his personal digital assistant (“PDA”) or hard drive, for example. The audio corpus 140 may be the creation of the user. An ML search 160 of the audio corpus 140 feature stream is then conducted with respect to the new search-specific model 130 and a garbage model 150. The garbage model 150 is an HMM that is trained on sounds not found in the search phrase and may also represent background noises and other non-speech sounds.

The second ML search 160 is tailored to the simpler acoustic models such as the search-specific model 130 and the garbage model 150 by dynamically pruning the search. New start states are added at each frame. A new start state is a new path that is created at each time index. Low scoring and long state sequences, with respect to the search utterance, are pruned away at each frame. Dynamically increasing and pruning the search has the advantage that explicit endpointing is not required. Duration of sub-word units is specifically modeled in the transition probabilities drawn from the sample utterance. Utterance duration, as measured by the length of the sample utterance, is used to trim the search. The score from the garbage model 150 serves as a best path point of reference. Locations in the feature stream where the scores of the new HMM 130 are significantly higher than the garbage model 150 are marked as possible matches. The highest scoring matches are then presented as results of the search.

Since audio notes are typically easy to create but can be hard to identify in a large collection at a later time, conducting audio searches using spoken example text provides a useful function on handheld devices that have audio interfaces, yet cumbersome or completely unavailable keyboard input. As an illustration, imagine a situation where an individual records a conversation with a neighbor on a PDA. Later, the individual wishes to locate all occurrences of a specific term, “cat.” The individual recites “cat” into the PDA. The recited word becomes the audio search term 110.

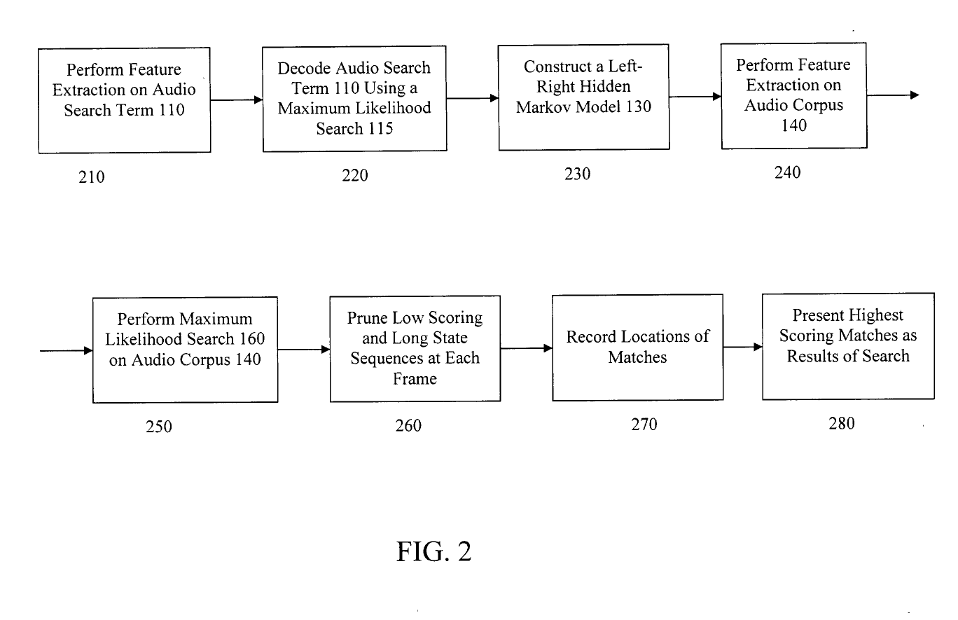

As shown in operation 210 of FIG. 2, feature extraction is performed on the audio search term 110, “cat.” A best state sequence for the utterance, a phonetic transcript of sorts, is then returned through maximum likelihood decoding 115, such as through a Viterbi recursive computational procedure, as illustrated in operation 220. As depicted in operation 230, a new HMM 130 is constructed having a defined number of states and transition duration information that leverages speaking style. The new HMM 130 may, for example, be presented as silence followed by a hard “c” sound, followed by an “a” sound, followed by a “t” sound, followed by additional silence. The audio corpus 140 is to be searched for this sequence of sounds. As shown in operation 240, feature extraction is performed on the audio corpus 140. This operation may also be performed at the time when the audio corpus 140 is created. The sounds are then decoded through an ML search 160, as illustrated in operation 250. At each frame, low scoring and long state sequences are discarded, as depicted in operation 260. Operation 270 then records the locations of matches. The highest scoring matches are then presented as results of the search, as illustrated in operation 280.

While the above description refers to particular embodiments of the present invention, it will be understood to those of ordinary skill in the art that modifications may be made without departing from the spirit thereof. The accompanying claims are intended to cover any such modifications as would fall within the true scope and spirit of the present invention. The presently disclosed embodiments are therefore to be considered in all respects as illustrative and not restrictive; the scope of the invention being indicated by the appended claims, rather than the foregoing description. All changes that come within the meaning and range of equivalency of the claims are therefore intended to be embraced therein.

What is claimed is

1. A system for audio searches, comprising:
a general acoustic model, representing speech sounds; and
a garbage model, representing speech and non-speech sounds, wherein the system is capable of:
performing feature extraction on an audio corpus and on an audio search term;
decoding the audio search term using a maximum likelihood search;
using a resulting state sequence from the maximum likelihood search and parameters from the general acoustic model to construct a new model with a plurality of states;
assigning state transition probabilities to the new model given maximum likelihood state occupancy durations from the maximum likelihood search;
conducting an audio corpus maximum likelihood search with respect to the new model and the garbage model;
discarding low scoring and long state sequences at each of a plurality of frames, with respect to duration of the audio search term; and
recording locations and scores of matches and presenting results of the search.

2. The system of claim 1, wherein the feature extraction converts a speech waveform into a parametric representation that is used for analysis and processing.

3. The system of claim 1, wherein the maximum likelihood search is used to find a most probable sequence of hidden states given a sequence of observed data, and a maximum likelihood score is calculated with respect to the general acoustic model.

4. The system of claim 1, wherein the new model is a left-right hidden Markov model.

5. The system of claim 1, wherein the garbage model is trained on speech and background noise.

6. The system of claim 1, wherein locations of matches are determined at places in which scores of the new model are substantially higher than scores of the garbage model.

7. A method of conducting audio searches, comprising:
performing feature extraction on an audio corpus;
processing an audio search term to perform feature extraction;
decoding the audio search term using a maximum likelihood technique;
generating a model, that has at least one state, from parameters of an acoustic model and from a result of the maximum likelihood technique, including state durations;
allocating state transition probabilities to the model given maximum likelihood state occupancy durations from the maximum likelihood technique;
performing an audio corpus maximum likelihood search with respect to the model and a garbage model;
pruning low scoring and long state sequences at each of a plurality of frames, with respect to the search duration;
recording locations and scores of matches; and
introducing the locations of matches as results of the search.

8. The method of claim 7, wherein the maximum likelihood technique is carried out with respect to the acoustic model that produces a maximum likelihood score.

9. The method of claim 8, wherein the maximum likelihood technique is used to find a most probable sequence of hidden states, given a sequence of observed data, and a maximum likelihood score is calculated with respect to the acoustic model.

10. The method of claim 7, wherein the model is a left-right hidden Markov model.

11. The method of claim 7, wherein the garbage model is trained on speech and background noise.

12. The method of claim 11, wherein the garbage model generates a score that serves as a best path point of reference.

13. The method of claim 7, wherein feature extraction converts a speech waveform into a parametric representation for analysis and processing.

14. The method of claim 7, wherein locations of matches are determined at places in which scores of the model are higher than scores of the garbage model.

15. An article comprising:
a storage medium having stored thereon instructions that when executed by a machine result in the following:
processing an audio search term for feature extraction;
performing maximum likelihood decoding on the audio search term;
generating a model, having one or more search model states, from a resulting state sequence from the maximum likelihood decoding and from an acoustic model;
assigning state transition probabilities to the model, given maximum likelihood state occupancy durations from the maximum likelihood decoding;
performing feature extraction on an audio corpus;
performing maximum likelihood decoding on the audio corpus with respect to the model and a garbage model;
removing low scoring and long state sequences with respect to search sample duration;
logging locations and scores of matches; and
presenting results of the matches.

16. The article of claim 15, wherein feature extraction converts a speech waveform into a parametric representation that is used for analysis and processing.

17. The article of claim 15, wherein the maximum likelihood decoding finds a most probable sequence of hidden states from a sequence of observed data, and a maximum likelihood score is calculated with respect to the acoustic model.

18. The article of claim 15, wherein the one or more search model states proceed from left to right in the model.

19. The article of claim 15, wherein locations of matches are determined at places in which scores of the model are higher than scores of the garbage model.

20. The article of claim 15, wherein the garbage model is trained on speech and background noise.
